(19) United States
(12) Patent Application Publication
(10) Pub. No.: US 2006/0285162 A1
(43) Pub. Date: Dec. 21, 2006

(54) Image forming apparatus

(75) Inventor: Mikimasa Honma, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/410,164

(22) Filed: Apr. 25, 2006

(30) Foreign Application Priority Data
Jun. 17, 2005 (JP) JP2005-177691

(51) Int. Cl. G06K 15/00

(52) U.S. Cl. 358/1.18

(57) ABSTRACT

An image forming apparatus including: an image forming section for forming images on both surfaces of a recording medium; and a control section for controlling the image forming section to form, on each surface of the recording medium, a first image and image each including a test chart image for detecting a deviation between image formation areas on both surfaces of the recording medium; wherein at least one of the image and the second image includes an identification image for identifying a reference surface and the other surface the recording medium.

### CROSS REFERENCE TO RELATED APPLICATION

The present application is based on Japanese Patent Application No. 2005-177691 filed with Japan Patent Office on Jun. 17, 2005.

### BACKGROUND OF THE INVENTION

1. Field of the Invention

The present invention relates to an image forming apparatus, particularly to an image forming apparatus wherein a visible identifier is attached to the test chart for adjusting the area for image formation at the time of double-sided printing, thereby facilitating the user's adjustment work.

2. Description of Related Art

In the image-forming apparatus such as a copying machine, printer and facsimile, a technique for adjusting the area for image formation on a substrate has been known.

As an example of the technique for adjusting the image formation areas on the front and back in double-sided printing, Unexamined Japanese Patent Application Publication No. 2004-25784 discloses an image forming apparatus, wherein the pattern capable of viewing the timing error is outputted and an identifier is attached to associate this pattern with the reference pattern, whereby the amount of adjustment is grasped. Unexamined Japanese Patent Application Publication No. 2003-280466 discloses an image forming apparatus having a front and back adjustment mode for adjusting the print patterns of the front and back of the substrate, wherein the outputted adjustment patterns are read by a document reading section, and the image print position on the back and magnification are corrected in conformity to the image print position on the front. Unexamined Japanese Patent Application Publication No. 2003-262990 discloses an image forming apparatus wherein the print patterns on the front and back are viewed from the front, and the image formation areas on the front and back are adjusted.

In the image forming apparatus wherein images are formed on both sides, when the image formation areas are to be aligned, a test chart is outputted wherein the image formation area is printed on each of the front and back, based on the currently set image output position data. By actually making comparison of the test charts, a user measures the difference in the image formation area on the front and back, using a scale or the like. The result of the measurement is inputted as a correction value into the adjustment mechanism of the image forming apparatus. Adjustment is made to ensure conformance of the image formation areas of the front and back.

The conventional test chart, however, merely shows the image formation areas on the front and back, without giving a distinction between the front and back. To put it another way, the difference obtained from the test charts of the front and back is inputted as a correction value into the adjustment mechanism for adjusting the image formation area(s). In the adjustment mechanism, the image formation area on either the front or back set currently is used as a reference. In conformity to this reference, the image formation area of the surface not used as a reference is corrected according to the correction value. Thus, even if the user compares the test charts and measures the difference, the adjustment of the image formation area will become difficult if the surface serving as a reference cannot be identified.

Further, in the image forming apparatus for image formation on both surfaces, the front and back of the substrate is reversed to form an image. The substrate moving direction when the image formation is performed first is reverse to that when it is performed latter. Thus, when the correction value is inputted, it is complicated to determine whether a positive correction value or a negative correction value should be inputted with respect to the reference surface.

### SUMMARY OF THE INVENTION

The object of the present invention is to find out a method for easy and reliable adjustment of the image formation area on the front and back surfaces in an image forming apparatus for image formation on both surfaces.

(1) An embodiment of the image forming apparatus reflecting one aspect of the present invention includes:

an image forming section for forming images on both surfaces of a recording medium; and

a control section for controlling the image forming section to form, on each surface of the recording medium, a first image and a second image each including a test chart image for detecting a deviation between image formation areas on both surfaces of the recording medium;

wherein at least one of the first image and the second image comprises an identification image for identifying a reference surface and the other surface of the recording medium.

(2) The image forming apparatus of (1) preferably further includes a designation section for designating one of the surfaces of the recording medium as the reference surface, wherein the control section generates the first image and the second image according to designation of the reference surface by the designation section.

(3) In the image forming apparatus of (1), the aforementioned identification image preferably includes an image indicating a positive/negative direction when measuring a deviation between test chart images formed on the reference surface and the other surface.

(4) In the image forming apparatus of (1), the identification image preferably includes an image indicating order of measurement when measuring the deviation between the test chart images formed on the reference surface and the other surface.

(5) In the image forming apparatus of (1), only one of the first image and second image contains the identification image, preferably. That is to say, single identification image on either of two surfaces of the recording medium is sufficient for identifying both of the reference surface and the other surface.

### BRIEF DESCRIPTION OF THE DRAWINGS

These and other objects, advantages and features of the invention will become apparent from the following description thereof taken in conjunction with the accompanying drawings in which:

FIG. 1 is a diagram representing the overall arrangement of the image forming apparatus according to the present invention;

FIG. 2 is a block diagram representing the arrangement of the control circuit of the image forming apparatus according to the present invention;

FIG. 3 is a schematic view showing the outline of the operation section of the image forming apparatus according to the present invention; wherein the liquid crystal display indicates the screen in the initial state;

FIG. 4(a) is a schematic diagram showing an example of the front of the test chart printed from the image forming apparatus according to the present invention;

FIG. 4(b) is a schematic diagram showing an example of the back of the test chart;

FIG. 5 is a flowchart representing the operation of the image forming apparatus according to the present invention;

FIG. 6 is a schematic diagram showing an example of measuring the image print position using the test chart printed from the image forming apparatus according to the present invention;

FIG. 7 is a schematic diagram showing an enlarged view of a part of the example of measuring the image print position in FIG. 6;

FIG. 8(a) and FIG. 8(b) are schematic diagrams showing an example of the liquid crystal display in the “image print position adjustment mode” in the image forming apparatus according to the present invention;

FIG. 9(a) is a schematic diagram showing another example on the front of the test chart printed by the image forming apparatus according to the present invention; and

FIG. 9(b) is a schematic diagram showing another example on the back of the test chart printed by the image forming apparatus according to the present invention.

### DETAILED DESCRIPTION OF THE PREFERRED EMBODIMENT

Referring to the drawings, the following describes the best forms of embodiments of the image forming apparatus according to the present invention.

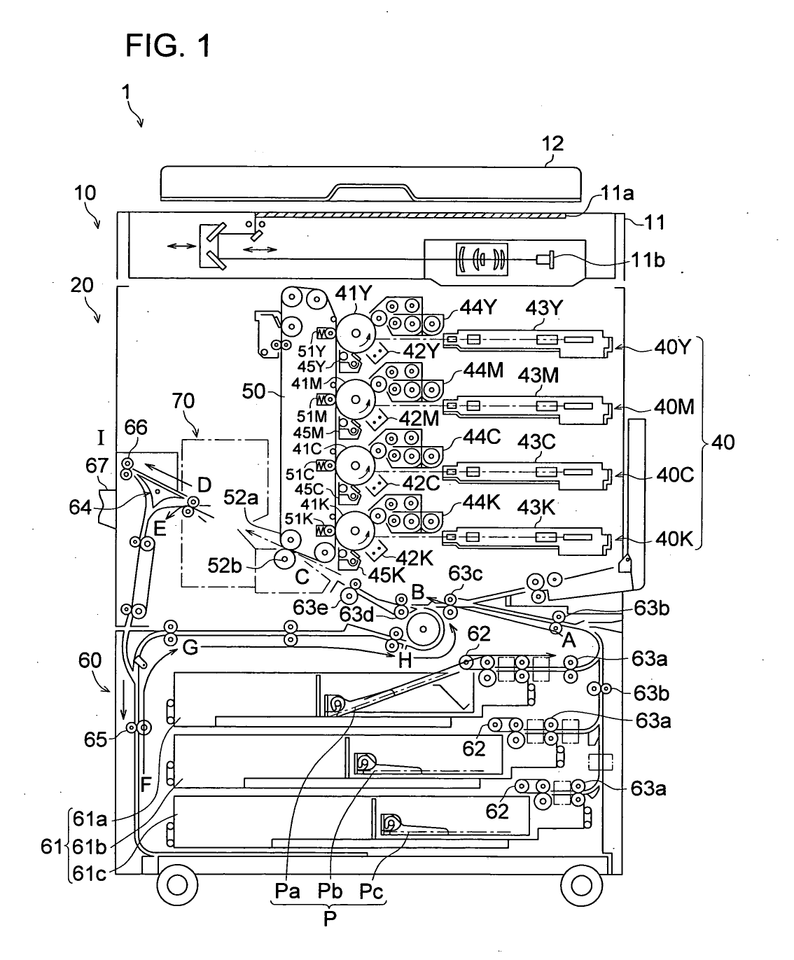

FIG. 1 is a diagram representing the overall arrangement of the image forming apparatus 1. The image forming apparatus 1 is made of an image reading section 10 and image forming apparatus main body 20. The image reading section 10 is arranged on the upper portion of the image forming apparatus main body 20.

The scanner 11 reads the image of the document placed between the platen glass 11a and scanner cover 12. Light is projected on the document and the reflected light is captured by the CCD (Charge Coupled Device) 11b. Electronic data is generated by photoelectric conversion from the light having been captured, and is outputted RGB-based image data to the control circuit 80 to be described later.

The image forming apparatus main body 20 is made up of an image forming section 40, intermediate transfer belt 50, primary transfer rollers 45Y, 45M, 45C and 45K, secondary transfer roller 52a and 52b, fixing section 70 and sheet feed section 60. Each section forms an image on the substrate P according to the instruction from the control circuit 80 based on the image data read by the scanner 11 of the image reading section 10, and outputs it.

The image forming section 40 includes a yellow image forming section 40Y, magenta image forming section 40M, cyan image forming section 40C and black image forming section 40K. The image forming sections largely have common structures. For simplicity, they will be described mainly based on the yellow image forming section 40Y as an example.

The yellow image forming section 40Y includes a photoreceptor drum 41Y, charging device 42Y, exposure apparatus 43Y, development apparatus 44Y and cleaning apparatus 45Y. The yellow image is formed on the photoreceptor drum 41Y based on the yellow (Y) image data supplied from the control circuit 80. In the control circuit 80, the RGB image data supplied from the image reading section 10 is processed into the Y, M, C, K-color image data made up of yellow (Y), magenta (M) and cyan (C) as three primary colors, plus black (K). The image data of each color is supplied to the image forming section 40Y, 40M, 40C and 40K. In the present embodiment, a tandem system image forming mechanism is used. The toner image of each color is transferred from the image data decomposed into four colors, onto the intermediate transfer belt 50 to be described later and an image is formed (printed) on the substrate P.

Based on the yellow image data supplied from the control circuit 80, the exposure apparatus 43Y allows an electrostatic latent image to be formed on the photoreceptor drum 41Y. To put it another way, scanning exposure of the yellow (Y) image is provided by the semiconductor laser through the laser optical system.

The surface of the photoreceptor drum 41Y is negatively charged by a charging device 42Y uniformly in advance. A laser beam is applied from the exposure apparatus 43Y based on the image data. Electrical charge is neutralized at the portion exposed to the laser beam. An electrostatic latent image is formed in the neutralized area.

The development apparatus 44Y is loaded with the yellow toner in advance. Toner is supplied to the electrostatic latent image formed on the photoreceptor drum 41Y and a toner image is developed. The toner is negatively charged in advance and the toner is stirred adequately by a built-in blade member in order to improve deposition on the photoreceptor drum 41Y. Negatively charged toner (yellow (Y) toner) is deposited on the surface of the photoreceptor drum 41Y with an electrostatic latent image formed thereon by exposure apparatus 43Y. Then the electrostatic latent image is developed. To be more specific, toner is not deposited on the area still negatively charged without being exposed to the laser beam. Toner is deposited on only the area (electrostatic latent image) where electrostatic charge is neutralized by laser beam.

The photoreceptor drum 41Y carrying the toner image subsequent to the development of the electrostatic latent image transfers the toner image on the intermediate transfer belt kept in contact in parallel to the direction of the drum axis. After the toner image has been transferred, the residual toner deposited on the surface of the photoreceptor drum 41Y and residual charge are removed by the cleaning apparatus 45Y. The surface of the photoreceptor drum 41Y is cleaned.

As described above, the toner image of each color is subjected to primary transfer onto the intermediate transfer belt in the order of image forming sections of yellow (Y), magenta (M), cyan (C) and black (K), whereby one toner image is formed.

The intermediate transfer belt 50 is rotatably supported by a plurality of rollers. It is arranged so as to pass between the photoreceptor drums 41Y, 41M, 41C and 41K and primary transfer rollers 51Y, 51M, 51C and 51K. The primary transfer roller 51Y is provided with the force to be pressed in the direction of the photoreceptor drum 41Y by an elastic body (such as a spring and rubber of various kinds). It allows the intermediate transfer belt 50 to be pressed against the photoreceptor drum 41Y, with the result that each of the toner images of yellow (Y), magenta (M), cyan (C) and black (K) deposited on the photoreceptor drum 41Y is transferred on the intermediate transfer belt.

The toner images having been subjected to primary transfer one on top of another sequentially onto intermediate transfer belt 50 is fed to the secondary transfer rollers 52a and 52b by the drive of the support roller supporting the intermediate transfer belt 50. The secondary transfer rollers 52a and 52b allow the toner images to be collectively transferred onto the substrate P having been feed from the sheet feed section 60 to be described later (secondary transfer). The substrate P holding the images having been subjected to secondary transfer is fed to the fixing section 70. Toner is fixed by heat fusing, whereby the color image is completed formed.

The following describes the sheet feed section 60. The sheet feed section 60 includes sheet feed tray 61, feed-out roller 62, sheet feed roller 63a, conveyance rollers 63b, 63c and 63d, registration roller 63e, branch point 64, reversing control roller 65, ejection roller 66 and ejection tray 67. The sheet feed section 60 feeds the substrate P stored in the sheet feed tray 61 to the ejection tray 67 along a predetermined feed path (a series of guide rails for guidance from spot A through spot I given in FIG. 1). Further, the substrates Pa, Pb and Pc of various sizes are stored in the sheet feed trays 61a, 61b and 61c, and substrates of various sizes are fed as appropriate according to the control circuit 80 and user's choice.

The branch point 64 and reversing control roller 65 serve as a stepper for reversing and conveying the front and back of the substrate P at the time of double-sided printing. The following describes the conveyance mechanism when the substrate P is printed in the single-sided and double-sided printing modes.

When an image is formed and outputted on one side, the substrate P is fed from the sheet feed tray 61 to the branch point 64 through the spots A, B, C and D. In this case, in response to transfer (secondary transfer) of the toner image developed on the intermediate transfer belt 50 at the spot C, the image is transferred onto one side of the substrate P. In the single-sided printing mode, the branch point 64 closes the guide rail for guidance in the direction E. The substrate P is ejected to the ejection tray 67 provided at the spot I.

When the image is formed and outputted on both sides, the substrate P is fed from the sheet feed tray 61 to the branch point 64 through the spots A, B, C and D. Similarly to the case of single-sized-printing mode, in response to the transfer (secondary transfer) of the toner image at the spot C along the way, the image is printed on one side of the substrate P. In the double-sided printing mode, the branch point 64 closes the guide rail for guidance in the direction of spot I, and opens the guide rail for guidance in the direction of spot E. The substrate P fed to the spot E is conveyed in the order of spots F, G, H, B, C and D, and is ejected from the spot I. When it is fed from spot F to spot G, the print surface of the substrate P is reversed. To be more specific, the tip of substrate P conveyed from the spot E is directed to the ground at the spot F. After that, when it is conveyed to the spot G by the reversing control roller 65, the front and back of the substrate P are replaced with respect to toner image carried by the intermediate transfer belt. Toner is transferred to the back of the substrate P where the front and back are replaced at the spot C, and the image formation is completed in the double-sided printing mode.

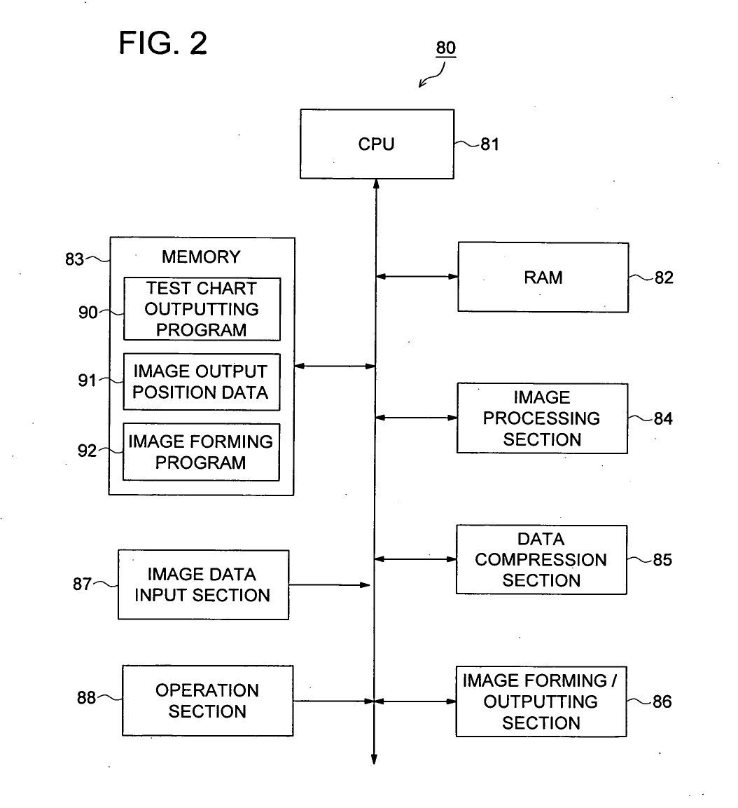

The following describes the control circuit 80 of the image forming apparatus 1. FIG. 2 shows the arrangement of the control circuit 80. The control circuit 80 contains a CPU (Central Processing Unit) 81, RAM (Random Access Memory) 82, image processing section 84, image data compression section 85, image forming/outputting section 86, image data input section 87, operation section 88 and the memory 83.

The CPU 81 reads the system program (not illustrated) previously stored in the memory 83 to be described later. It expands the system program on the RAM 82 as the work area and provides the overall control of the image forming apparatus 1. It sends to each section of the image forming apparatus 1 the instruction signal for giving instructions of drive and processing.

The image data input section converts the image data of the RGB signal format supplied from the scanner 11 (FIG. 1), into the signal format of Y, M, C and K, and supplies it to each portion of the control circuit 80. In the normal operation, an image is formed based on the image data supplied from the image data input section.

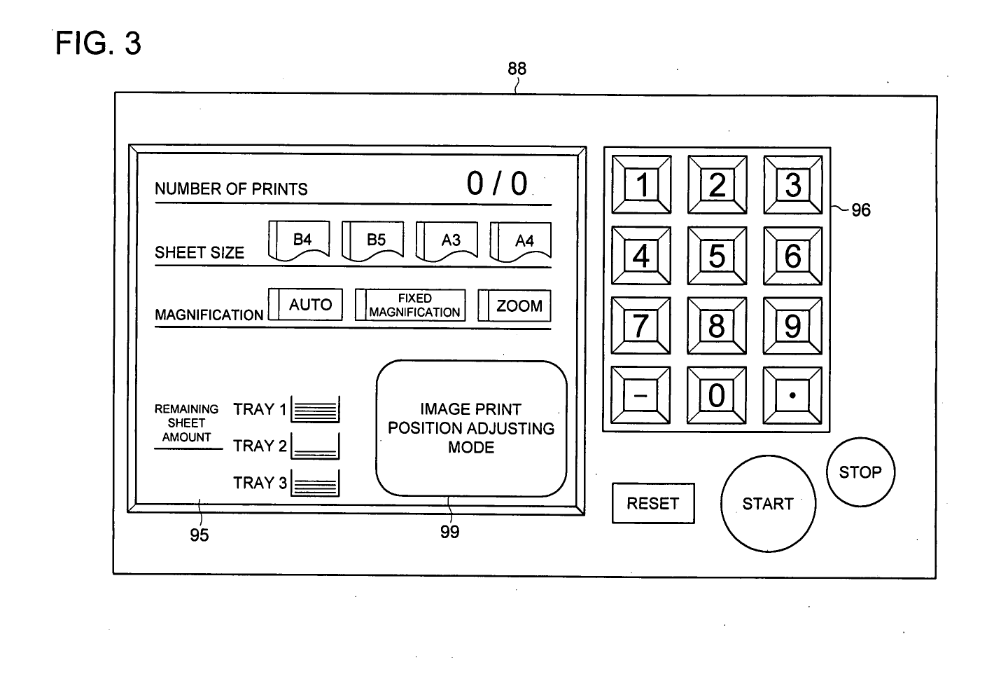

As shown in FIG. 3, the operation section 88 includes the liquid crystal display 95 and a wide variety of the operation key 96. In response to the user operation, a wide variety of instruction signals are outputted to the CPU 81 and others. In the present embodiment, it is used to give an instruction to activate the “image print position adjustment mode”, to designate the reference surface of the double-sided printing test chart, and to input the correction value (deviation) measured by comparison of test charts.

The liquid crystal display 95 provides predetermined display processing according to the display signal supplied from the CPU 81. In the present embodiment, the liquid crystal display 95 shows various forms of guidance of processing to be applied in the “image print position adjustment mode” to be described later (e.g. input screen of the measured value of the print chart). Further, the liquid crystal display 95 is designed in a touch panel arrangement. The operation can be performed in response to a various icons displayed on the liquid crystal display 95.

Various operation keys 96 output the depression signals generated by user's pushbutton operation, to the CPU 81. In the present embodiment, various operation key 96 are also used to input the measured values of the print chart in the “image print position adjustment mode”.

The image processing section 84 applies various forms of image processing such as processing of color, brightness and contrast to the image data read by the scanner 11 and outputted from the image data input section 87.

The image forming/outputting section 86 outputs to the image forming section 40 the image data subjected to predetermined image processing in the image processing section 84 (FIG. 1). It also outputs the control signal that specifies the semiconductor laser scanning range and direction of scanning. For example, in the double-sided printing mode, the toner images formed on the intermediate transfer belt 50 are reverse to each other on the front and back. To be more specific, the scanning laser beam image projected to the photoreceptor drum 41Y from the exposure apparatus 43Y when forming an electrostatic image for the front surface is reversed from the image for the back surface. The image forming/outputting section 86 controls the data flow for each item of image data.

The memory 83 is made up of a nonvolatile memory such as a hard disk and EPROM (Erasable Programmable ROM). It stores the system program that can be implemented by the image forming apparatus 1, various processing programs that can be implemented by the system program, the data used to implement these processing programs, and the data on the result of computation and processing by the CPU 81. The memory 83 also stores the test chart output program 90, image output position data 91 and image forming program. In the normal operation, it is used for temporary storage of the image data supplied from the scanner 11.

The image forming program 92 is a program for controlling the image formation to be performed according to the image data previously stored in the image data input section 87 and memory 83.

The image output position data 91 is a set value to define the area of printing when printing on the substrate P. It denotes the values for the print start position from the leading edge as viewed in the moving direction of the substrate P, and for the print start position and edge position as viewed from the edge of the substrate P across the width.

The test chart output program 90 is a program to activate the “image print position adjustment mode” in response to the instruction signal from the operation section 88. Based on the image output position data 91, the test chart output program 90 outputs the test chart showing the printable area of the substrate P. The test chart data is included as part of the test chart program 90. The image data of the test chart can be managed in the memory 87 separately from the test chart program 90.

The following describes the “image print position adjustment mode”. Based on the image output position data, the image forming apparatus 1 performs image printing operations in a predetermined area on the substrate P. Adjustment of the print area of this image is processed by the “image print position adjustment mode”. To put it more specifically, in the image position adjustment in the double-sided printing mode, the image data of the test chart is expanded according to the image output position data. A test chart is printed out, wherein the identifier showing the image print area is printed on both sides. Various parameters shown in this test chart are measured by the user with a scale and others. If the user considers that a deviation is present, the amount of deviation is inputted by the operation section 88 to be described later. Based on the amount of deviation having been inputted, the CPU 81 performs computation for correction of the print area. The print area is adjusted inside the image forming apparatus 1. In particular, when the print area is adjusted in the double-sided printing mode, the image forming apparatus 1 is capable of outputting the test chart provided with identifier that can be clearly viewed by the user to determine which of the front and back should be used as a reference side in order for computation for correction to be performed in the image forming apparatus 1.

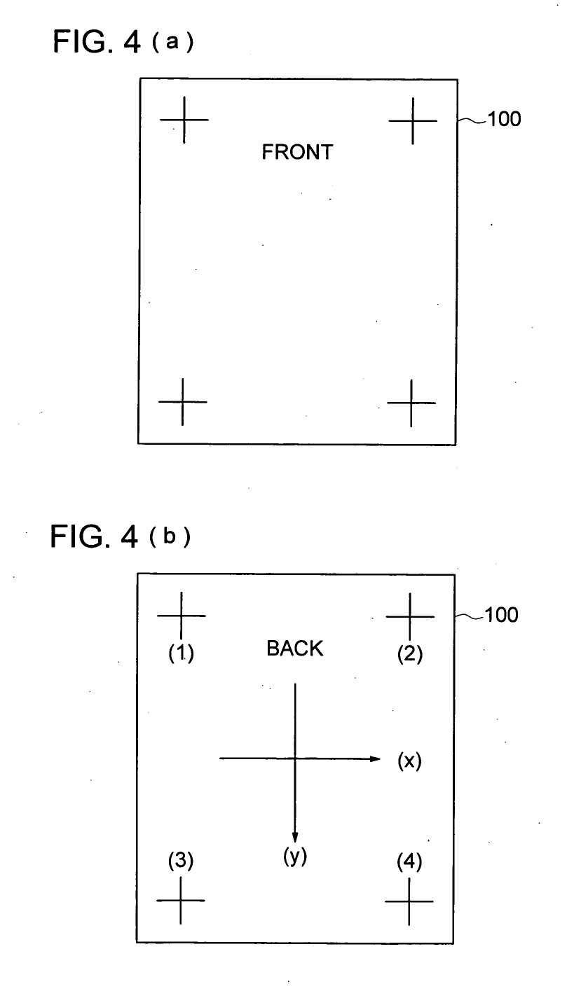

FIGS. 4(a), (b) show an example of the test chart to be outputted in the “image print position adjustment mode”. The substrate P is conveyed in the longitudinal direction in the image forming apparatus 1. In the following description, the edge of the substrate P in the longitudinal direction (the edge in the longitudinal direction shown in FIG. 4) is called the “edge in the moving direction”.

FIG. 4(a) is a test chart printed on the front of the substrate P. A “cross mark” showing the print area of an image is printed at four corners. In the normal operation, printing is carried out within the square area bounded by the “cross mark” located at four corners. FIG. 4(b) shows a test chart printed on the back of the substrate P. Similarly to the case on the front, four “cross marks” are printed on the print area. The x and y coordinate axes are printed close to the center thereof. In each coordinate axis, the y axis is parallel to the edge of the moving direction of the substrate, and the direction of the arrow mark indicates the positive direction of the numeral value. The x axis is parallel to the edge orthogonal to the edge of the substrate P in the moving direction. The direction of the arrow mark indicates the positive direction of the numeral value. The positive direction of this numeral value is determined. This is to show the features of the reversing mechanism of the substrate P in the aforementioned double-sided printing. As shown in FIG. 1, when the substrate P is again fed from the path F for printing on the back, the edge opposite to the hitherto leading edge in the moving direction becomes the leading edge, and the substrate P is fed toward the secondary transfer rollers 52a and 52b. Thus, if the moving direction at the time of secondary transfer on the front is assumed as positive, then the moving direction at the time of secondary transfer on the back is negative. Assume that, in the double-sided printing mode, adjustment of the print area on the front and back is made in such a way that the print area on the back is determined based on the print area on the front as a reference. Then when the user inputs the measured value into the operation section 88, the positive and negative relationship will be complicated, and correct inputting may not be ensured. In order to solve such a problem, the coordinate axis is printed out to ensure easy and correct inputting of the measured value by the user.

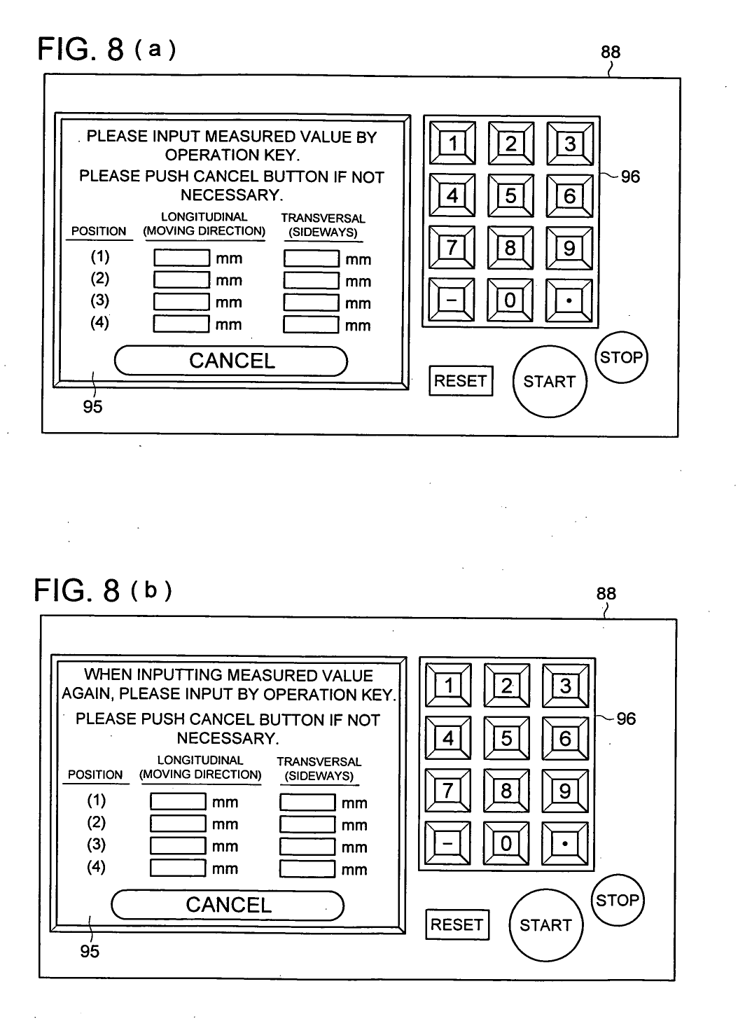

Numbers from 1 through 4 are printed on the “cross marks”, respectively. They are used so that the user can be aware of the order of input, when the user measures the amount of deviation and inputs the measured value through the operation section 88. To put it more specifically, an example will be taken from the display on the liquid crystal display 95 of the operation section 88 in the “image print position adjustment mode” shown in FIGS. 8(a), (b). The “position” in the indication of the liquid crystal display 95 shows the “cross mark” for measurement by the user. The longitudinal (moving direction) and transversal (sideways) indicate the positions where the difference of the reference surfaces from the “cross mark” is inputted. The user measures the “cross mark” shown by (1) on the substrate ((1) in FIG. 4(b)), and uses the operation key 96 to input the difference (the measured value) in the longitudinal and transversal directions, into the column corresponding to the position (1) ((1) in FIG. 4(b)) of the liquid crystal display 95. Similarly, the user measures the differences of (2) ((2) in FIG. 4(b)) through (4) ((4) in FIG. 4(b)) on the substrate from the “cross mark”, and inputs them sequentially in the corresponding column of the liquid crystal display 95. Thus, easy and correct measurement is ensured by correspondence between the order of measurement on the substrate and display columns of the liquid crystal display 95.

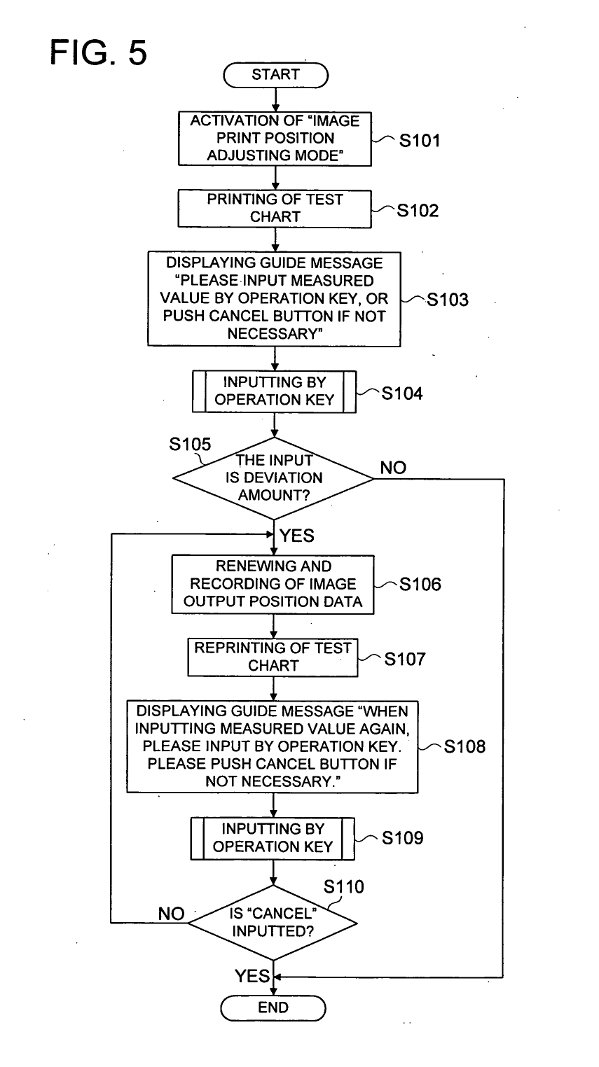

Referring to FIG. 5, the following describes the operation of the image forming apparatus 1 in the “image print position adjustment mode” of the image forming apparatus 1 having the aforementioned arrangement:

When the user operates the icon 99 of the “image print position adjustment mode” indicated on the liquid crystal display 95 (FIG. 3), the CPU 81 reads the test chart output program, and activates the “image print position adjustment mode” (Step S101).

The image data of the test chart stored in the memory 83 in advance is read, and the test chart 100 is printed based on the image output position data 91 indicating the current print area (Step S102). In this case, a message is indicated on the liquid crystal display 95, asking the user which side of the test chart 100 should be used as a reference. Either the front or back is designated as the reference side according to the input operation of the user. It is also possible to make such arrangements that either the front or back is determined as the reference side in advance, without being designated by the user.

In the test chart 100, “cross marks” are printed at four corners on the front and back, as shown in FIG. 4(a), (b). Each of the cross marks on the back is printed with the numbers indicating the order of measurement and the order of input into the operation section 88. Further, the front is printed with the “FRONT” as an identifier indicating that this surface is the front. Similarly, the back is printed with “BACK” showing that this surface is the back, and the x-y coordinates showing the positive/negative direction corresponding to the reference surface (front).

Using the test chart having been printed, the user observes the deviation of the print area of the front and back. At this time, referring to the “FRONT” or “BACK” printed on the front or back, the user can easily identify the front or back.

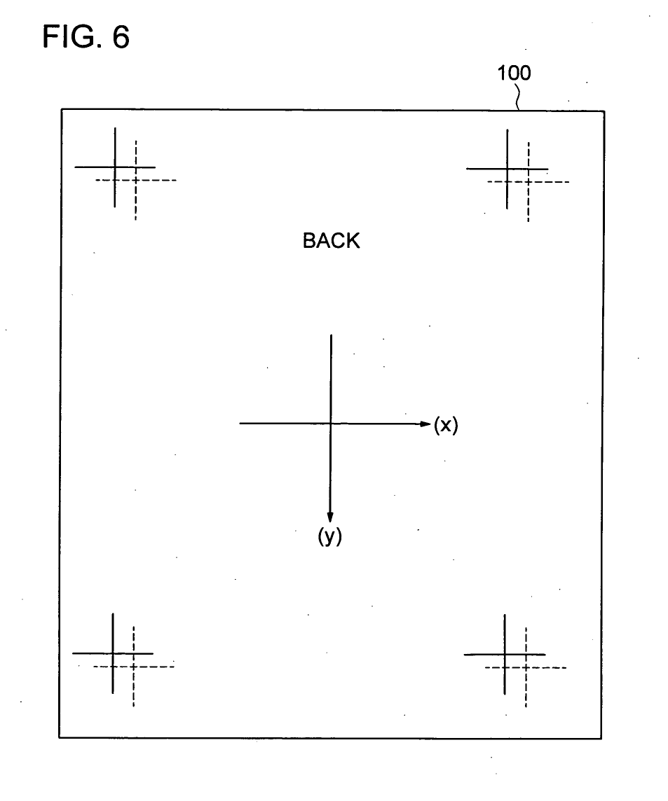

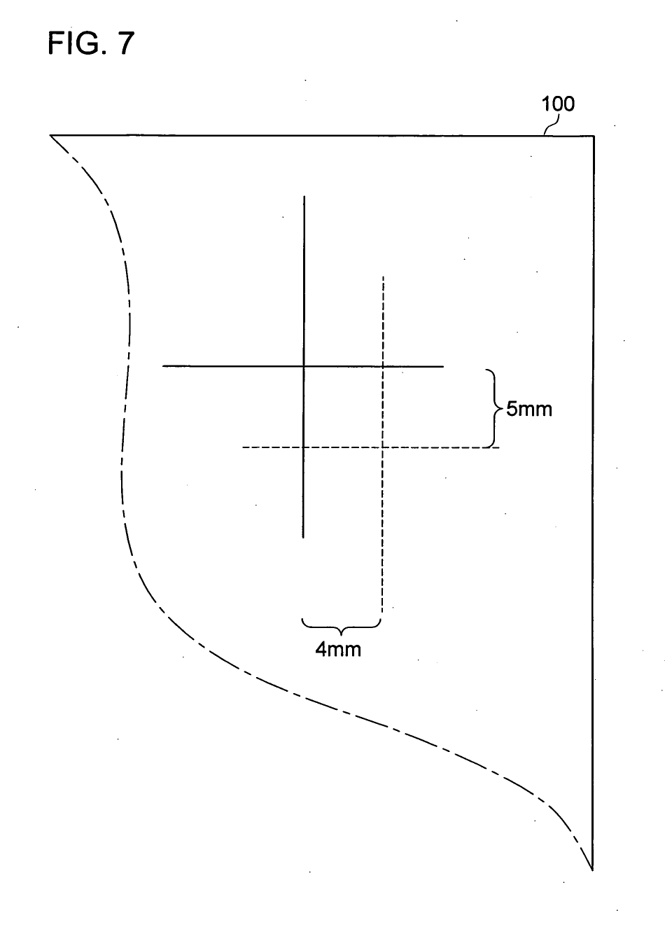

The user observes to check for agreement between the crossing point of the “cross mark” on the back and the crossing point of the “cross mark” on the front that can be observed through the substrate P (FIG. 6). If there is no agreement, the user employs a scale to measure the amount of deviation of the “cross mark” on the back with respect to the “cross mark” on the front. In this case, the distance between the two intersections having been printed is measured. Not only measuring the distance between both of the cross points, the x-y coordinates having been printed are used for measuring the deviations for each of the x- and y-components. Further, the measurement values are measured according to the x-y coordinates for each of the positive and negative directions. FIG. 7 shows an enlarged view of the “cross mark” on the upper right in FIG. 6. In FIG. 6, assume that the “cross mark” on the back is deviated from the “cross mark” on the front 5 mm opposite to the positive direction of the y axis and 4 mm opposite to the positive direction of the x axis. Then the measured value is −5 mm in the y-axis direction and −4 mm in the x-axis direction.

While the user measures the amount of deviation, liquid crystal display 95 shows the message, which reads “Please Input the measured value from the operation key. Push the Cancel Button if Not Necessary” (Step S103: FIG. 8(a). The system goes into the standby mode.

If there is no deviation as a result of user having measured the test chart 100, the Cancel item of the liquid crystal display 95 is operated and the “image print position adjustment mode” terminates (Step S105: NO).

If there is any deviation as a result of user having measured the test chart 100, the amount of deviation for each “cross mark” (the measured value) is inputted from the operation key 96 (Step S105: YES). The input value is indicated in each input item of FIG. 8(a). After that, the measured value data is supplied to the CPU 81.

Upon receipt of the measured value data, the CPU 81 updates the image output position data value in the back print mode according to the measured value data, and the updated data value is recorded in the memory 83 as new image output position data (Step S106).

After that, according to the updated image output position data 91, the test chart 100 is printed again (Step S107). To put it more specifically, for the deviation (deviation in the y-axis direction) of the substrate P in the moving direction, computation is made to correct the timing for synchronism between the registration roller 63e and intermediate transfer belt 50. For the deviation (deviation in the x-axis direction) of the substrate P orthogonal to the moving direction, computation is made to correct the scanning in the direction of main operation of the exposure apparatus 43Y and others.

When the test chart 100 is printed again, the identifier for front/back identification, the identifier showing the print area, and x-y coordinates are also printed.

Again observing the test chart 100 reflecting the measured value having been inputted previously, the user checks for presence/absence of a deviation by verification or measurement.

While the user is re-checking, the liquid crystal display 95 shows the message, which reads “When you want to input the measured value again, input it from the operation key. Press the Cancel if it is not required” (Step S108: FIG. 8(b). The system waits for input.

If there is no deviation as a result of user observation, i.e. if the Cancel of the liquid crystal display 95 has been operated (Step S110: YES), the “image print adjustment mode” terminates.

If a deviation has been detected a result of user observation, i.e. if the measured value has been inputted again (Step S111: NO), the system goes back to Step S107, where the image print position data is again updated and inputted. Based on the updated data, computation is made for correction of each section, and a test chart 100 is printed out.

As described above, when the user compares the deviations on the front and back using a test chart image formed on both sides of the recording medium P, the image forming apparatus 1 of the present embodiment allows the reference surface to be identified, based on the identifiers such as “FRONT” and “BACK” for identification of the reference surface and the other surface. The image forming apparatus 1 ensures correct identification of the surface where the image formation area is to be corrected.

When the x-y coordinates indicating the negative direction are further formed in addition to the identifier showing the reference surface, it is possible to identify whether the deviation value having been detected by measurement is positive or negative. This arrangement ensures easy and correct inputting of the correction value into the operation section 88.

A further identifier (FIG. 4(b)) showing the order of measurement of the test chart images is created. The order of measurement indicated by this identifier conforms to the order of the input items indicated on the liquid crystal display 95 of the operation section 88. This arrangement provides efficient and easy measurement of each of the visually approximate test charts and input of the correction values.

When the identifier indicating the positive and negative directions and/or the order of measurement is formed on either the reference surface or the other surface, the image forming apparatus 1 provides the identification information required for the user to measure test chart image deviation. For example, when the image formation areas on both surfaces are compared, assume that the user is observing the surface other than the reference surface. In this case, the user observes the test chart image of the reference surface through the substrate and measures the differences in the test chart images. When the difference is measured with a scale and others applied to the surface other than the reference surface, the positive/negative direction and/or the order of measurement can be directly identified by visual sense. This provides easy measurement procedure.

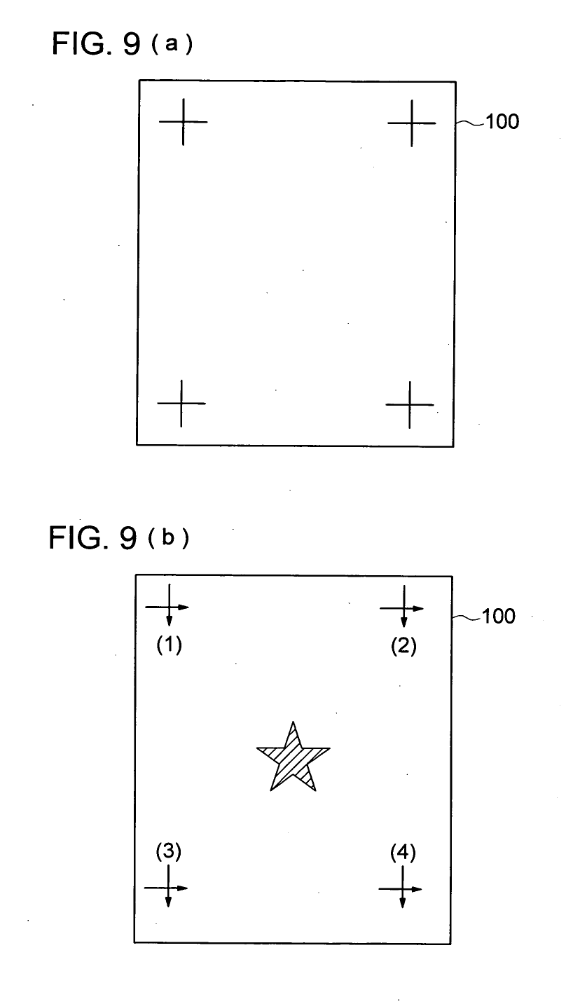

The best forms of the embodiments for implementation of the present invention have been described. It is to be expressly understood, however, that the present invention is not restricted thereto. For example, the identifiers for printing on the test chart 100 are only required to permit visual observation of the front and back of the substrate P, i.e. the reference surface of the image output position. For example, it is possible to make such arrangements that, as shown in FIG. 9, only the “cross mark” is printed on the reference surface (FIG. 9(a)), and the mark is printed only on the surface to be measured by the user (FIG. 9(b)). Alternatively, to determine the positive/negative of the numeral value when measuring the amount of deviation, an arrow mark can be put at the end of the “cross mark”, instead of using the x-y coordinates.

What is claimed is:

1. An image forming apparatus comprising:
an image forming section for forming images on both surfaces of a recording medium; and
a control section for controlling the image forming section to form, on each surface of the recording medium, a first image and a second image each including a test chart image for detecting a deviation between image formation areas on both surfaces of the recording medium;
wherein at least one of the first image and the second image comprises an identification image for identifying a reference surface and the other surface of the recording medium.

2. The image forming apparatus of claim 1, further comprising a designation section for designating one of the surfaces of the recording medium as the reference surface, wherein the control section generates the first image and the second image according to designation of the reference surface by the designation section.

3. The image forming apparatus of claim 1, wherein the identification image comprises an image indicating a positive/negative direction when measuring a deviation between test chart images formed on the reference surface and the other surface.

4. The image forming apparatus of claim 1, wherein the identification image comprises an image indicating an order of measurement when measuring the deviation between the test chart images formed on the reference surface and the other surface.

5. The image forming apparatus of claim 1, wherein only one of the first image and the second image comprises the identification image.

6. An image forming method comprising:
a first image forming step for controlling an image forming section to form, on a first surface of a recording medium, a first image including a test chart image for detecting a deviation between image formation areas on both surfaces of the recording medium; and
a second image forming step for controlling the image forming section to form, on a second surface of a recording medium, a second image including a test chart image for detecting the deviation between image formation areas on both surfaces of the recording medium;
wherein at least one of the first image and the second image includes an identification image for identifying a reference surface and the other surface of the recording medium.

7. The image forming method of claim 6, further comprising a designation step for designating any one of the surfaces of the recording medium as the reference surface, wherein in the first image forming step and the second image forming step, the first image and the second image are generated according to a designation of the reference surface in the designation step.

8. The image forming method of claim 6, wherein the identification image comprises an image indicating a positive/negative direction when measuring a deviation between test chart images formed on the reference surface and the other surface.

9. The image forming method of claim 6, wherein the identification image comprises an image indicating order of measurement when measuring the deviation between the test chart images formed on the reference surface and the other surface.

10. The image forming method of claim 6, wherein only one of the first image and the second image comprises the identification image.
